(19) United States
(12) Patent Application Publication
(10) Pub. No.: US 2023/0004462 A1
(43) Pub. Date: Jan. 5, 2023

(54) PERSISTENTLY STORING METADATA ASSOCIATED WITH A BACKUP OF DATA IN A SOURCE DATABASE

(71) Applicant: Microsoft Technology Licensing, LLC, Redmond, WA (US)

(72) Inventors: Min SHAO, Bellevue, WA (US); Austin DEAL, Seattle, WA (US); Manish TAWADE, Redmond, WA (US); Ankur JAUHARI, Bothell, WA (US); Max LEASON, Kirkland, WA (US); Sonia Kripasagar PARCHANI, Bellevue, WA (US)

(21) Appl. No.: 17/364,068

(22) Filed: Jun. 30, 2021

(51) Int. Cl. G06F 11/14

(52) U.S. Cl. CPC G06F 11/1435; G06F 11/1464; G06F 11/1469; G06F 11/1451; G06F 2201/80

(57) ABSTRACT

A system for persistently storing metadata associated with a backup of data in a source database. The system includes a cloud storage system and a source database. The source database includes a memory including data and a first electronic processor. The first electronic processor is configured to write a backup of the data included in the memory of the source database to the cloud storage system. The first electronic processor is also configured to write metadata associated with the backup of the data (“backup metadata”) to a table included in the memory of the source database. The backup metadata is used to retrieve the data when a target database is restored to a previous state of the source database.

### SUMMARY

In many information systems, performing backups for both user-initiated and system-initiated restores requires storing metadata about each individual backup in cloud storage. Currently, performing restores of source databases involves several high cost transactions. Many, if not all, of these high cost transactions involve reading and writing to cloud storage. During the backing up and restoration of a source database, every operation that requires metadata needs to read from or write to cloud storage. An example of metadata that is saved for a backup of a source database is illustrated in table 100 of FIG. 1. The backup metadata includes, for example, the time when the backup took place, the location of the backup data, the size of the backup data, and the like. The backup metadata may be used to develop a restore plan for restoring a source database to the state it existed at a previous point in time. For example, the time of the backup may be used to determine if the data included in the backup needs to be retrieved to restore the source database to the state it was in at a point in time selected by a user.

In some traditional deployments of a source database (for example, a Structured Query Language (SQL) database), backup metadata is retrieved by querying a system database (for example, a main storage database (MSDB)). However, in some implementations of a source database (for example, an Azure® SQL database), the system database is not resilient to failovers and the metadata may be lost. Therefore, in these implementations, the metadata is stored in a cloud storage system.

FIG. 2 illustrates an example of how a backup of data in a source database 200 is often performed in implementations where metadata cannot be stored persistently in a system database. A computer or electronic processor (not shown) associated with the source database 200 receives a request to backup the data in the source database 200 from a backup service 202 (step “1. backup request” in FIG. 2). The electronic processor transfers the data in local memory to the cloud storage system 205 (step “2. write backup to the cloud storage system” in FIG. 2). The electronic processor writes metadata regarding the backup to a system database (for example, a MSDB) (step “3. write metadata to MSDB” in FIG. 2). The electronic processor then sends confirmation to the backup service that the backup has been completed (step “4. backup completes” in FIG. 2). The electronic processor also sends the metadata associated with the backup to the backup service 202 (step “5. read backup metadata from MSDB” in FIG. 2). The backup service 202 sends the metadata associated with the backup to the cloud storage system 205 for storage (step “6. Stamp metadata on blob file” in FIG. 2).

FIG. 3 illustrates a method and system for restoring data from a source database when the data is backed up using the system and method illustrated in FIG. 2. Restoration of a source database occurs when a management service 300 receives a request from a user device 305 to restore a target database 310 to a point in time selected by a user. The management service 300 validates the restore request and sends a restore flag to an application programing interface (API) or communication layer (for example, a WinFab service fabric). The target database 310 calls the restore service 315. The restore service 315 retrieves metadata from the cloud storage system 205 and uses the retrieved metadata to generate a restore plan. The restore service 315 sends a T-SQL statement including the restore plan to the target database 310. The target database 310 uses the restore plan to retrieve, from the cloud storage system 205, the data needed to restore the target database 310 to the state it was in at the point in time selected by the user. It should be understood that the functionality described above as being performed by the backup service 202, management service 300, and restore service 315 is performed by an electronic processor executing the backup service 202, management service 300, and restore service 315. Additionally, source databases and target databases described herein may be user databases that store data associated with users or subscribers to a database service.

Among other things and benefits, embodiments described herein save computer resources by limiting the number of read and write operations (“reads” and “writes”) to and from the cloud storage system 205 that are performed during database backup and restoration. Some embodiments described herein accomplish this by writing metadata regarding backups to an internal table included in the source database 410 rather than to the cloud storage system 205. In some embodiments, the internal table may be used to allow users to view the backup history of their database. The embodiments described herein also allow erroneous restore requests to fail quickly, preserve backup data, allow for the restoration of geo-primary and geo-secondary databases, and extend restoration functionality by, for example, highlighting gaps in backup data in a restored (or target) database and corrupted backup data in a restored (or target) database.

In particular, one embodiment provides a system for persistently storing metadata associated with a backup of data in a source database. The system includes a cloud storage system and a source database. The source database includes a memory including data and a first electronic processor. The first electronic processor is configured to write a backup of the data included in the memory of the source database to the cloud storage system. The first electronic processor is also configured to write metadata associated with the backup of the data (“backup metadata”) to a table included in the memory of the source database. The backup metadata is used to retrieve the data when a target database is restored to a previous state of the source database.

Another embodiment provides a method of persistently storing metadata associated with a backup of data in a source database. The method includes sending, with a first electronic processor, a backup of data included in memory of a source database to a cloud storage system. The method further includes sending, with the first electronic processor, metadata associated with the backup of the data (“backup metadata”) to a table included in the memory of the source database. The backup metadata is used to retrieve the data when a target database is restored to a previous state of the source database.

Yet another embodiment provides a non-transitory computer-readable medium including instructions executable by an electronic processor to perform a set of functions. The set of functions include writing, with a first electronic processor, a backup of data included in memory of a source database to a cloud storage system. The set of functions also include writing, with the first electronic processor, metadata associated with the backup of the data (“backup metadata”) to a table included in the memory of the source database. The backup metadata is used to retrieve the data when a target database is restored to a previous state of the source database.

### BRIEF DESCRIPTION OF THE DRAWINGS

FIG. 1 illustrates an example of metadata that is saved for a backup of a source database.

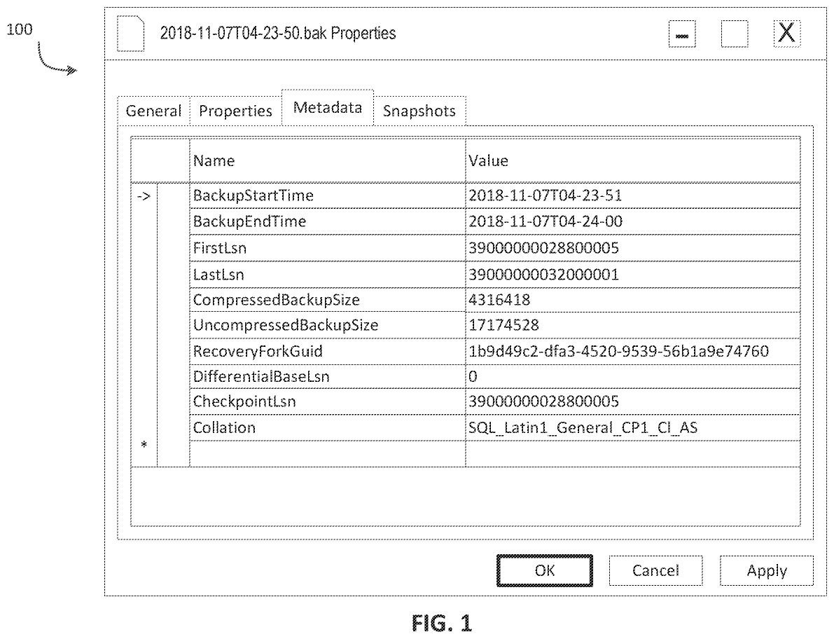

FIG. 2 illustrates an example system and method for backing up data in a source database where metadata cannot be stored persistently in a system database.

FIG. 3 illustrates an example system and method of restoring data from a source database when the data is backed up using the method illustrated in FIG. 2.

FIG. 4 schematically illustrates a system for persistently storing metadata associated with a backup of data according to some embodiments.

FIG. 5 is a flowchart illustrating a method performed by the system of FIG. 4 for storing metadata associated with a backup of data according to some embodiments.

FIG. 6 is an example graphical illustration of the method of FIG. 5.

FIG. 7 schematically illustrates a system for database restoration with a reduced number of reads and writes to and from a cloud storage system performed according to some embodiments.

FIG. 8 is a flowchart illustrating a method performed by the system of FIG. 7 for restoring a target database to a previous state of a source database according to some embodiments.

FIG. 9 is an example graphical illustration of the method of FIG. 8.

FIG. 10 illustrates an example system and method for restoring a target database to a previous state when the source database is unresponsive according to some embodiments.

FIG. 11 illustrates examples of systems and methods for periodically deleting backup data and backup metadata according to some embodiments.

FIG. 12 illustrates examples of systems and methods for detecting and restoring missing backup metadata according to some embodiments.

FIG. 13 illustrates examples of systems and methods for billing users using the system of FIG. 4 according to some embodiments.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way, but may also be configured in ways that are not listed. Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions.

As noted above, various embodiments of systems and methods for limiting the number of reads and writes required to be made to a cloud storage system during database back up and restoration are described. Some embodiments persistently store metadata associated with a backup of data in a source database. Currently, metadata regarding backups of a source database are stored in a system database (for example, a MSDB) or in a cloud storage system. However, in some database configurations (for example, Azure® SQL), a MSDB does not provide persistent storage for backup metadata. Therefore, in such database implementations, it is necessary to write backup metadata to and read backup metadata from the cloud storage system. Reading from and writing to the cloud storage system is costly, for example, in terms of both processing and bandwidth requirements.

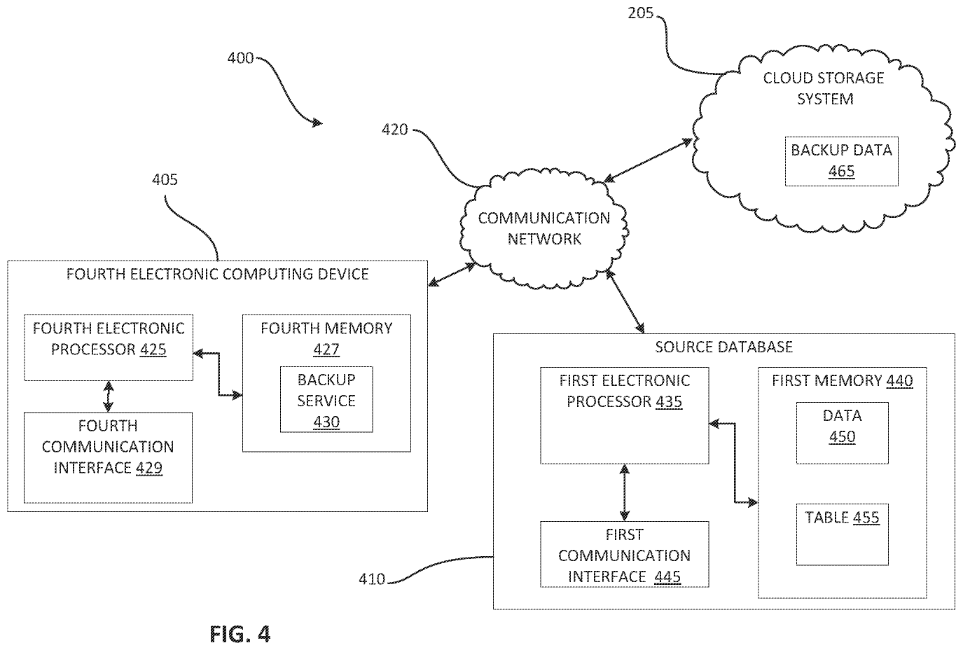

FIG. 4 provides an example illustration of a system 400 for persistently storing metadata associated with a backup of data in a source database. The system 400 includes a fourth electronic computing device 405, a source database 410, and a cloud storage system 205. It should be understood that the system 400 is provided as one example and, in some embodiments, the system 400 includes fewer or additional components in various configurations. Furthermore, in some embodiments, the system 400 may include a different number of source databases.

The fourth electronic computing device 405, source database 410, and cloud storage system 205 are communicatively coupled via a communication network 420. The communication network 420 may be implemented using a wide area network (for example, the Internet), a local area network (for example, an Ethernet or Wi-Fi™ network), a cellular data network (for example, a Long Term Evolution (LTE™) network), and combinations or derivatives thereof. In some embodiments, components of the system 400 communicate through one or more intermediary devices, such as routers, gateways, or the like (not illustrated).

The fourth electronic computing device 405 includes a fourth electronic processor 425 (for example, a microprocessor, application-specific integrated circuit (ASIC), or another suitable electronic device), a fourth memory 427 (for example, a non-transitory, computer-readable storage medium), and a fourth communication interface 429, such as a transceiver, for communicating over the communication network 420 and, optionally, one or more additional communication networks or connections. It should be understood that the fourth electronic computing device 405 may include additional components than those illustrated in FIG. 4 in various configurations and may perform additional functionality than the functionality described in the present application.

The fourth electronic processor 425, the fourth memory 427, and the fourth communication interface 429 included in the fourth electronic computing device 405 are communicatively coupled wirelessly, over one or more communication lines or buses, or a combination thereof. The fourth electronic processor 425 is configured to retrieve from the fourth memory 427 and execute, among other things, software to perform the methods described herein. For example, in the embodiment illustrated in FIG. 4, the fourth memory 427 includes a backup service 430. It should be understood that the fourth memory 427 may store additional software and the software stored in the fourth memory 427 (or other memory modules included in the fourth electronic computing device 405) may be distributed and combined in various configurations.

The source database 410 includes a first electronic processor 435, a first memory 440, and a first communication interface 445 similar to the fourth electronic processor 425, the fourth memory 427, and the fourth communication interface 429 described above. It should be understood that the source database 410 may include additional components than those illustrated in FIG. 4 in various configurations and may perform additional functionality than the functionality described in the present application.

The first electronic processor 435, the first memory 440, and the first communication interface 445 included in the source database 410 are communicatively coupled wirelessly, over one or more communication lines or buses, or a combination thereof. In the embodiment illustrated in FIG. 4, the first memory 440 includes data 450 and a table 455 that will be described in further detail below. It should be understood that the first memory 440 may store additional software and data and that the software and data stored in the first memory 440 may be distributed and combined in various configurations.

The cloud storage system 205 includes one or more computing devices (for example, servers) that include memory or cloud storage space on which backup data 465 from one or more source databases (for example, the source database 410) is stored.

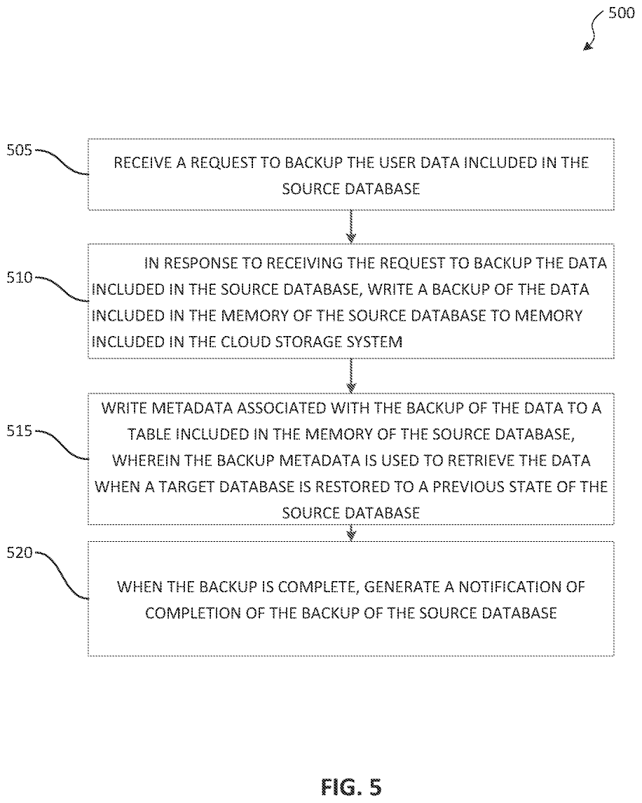

FIG. 5 illustrates an example method 500 for storing metadata associated with a backup of data. In some embodiments, the method 500 begins when the first electronic processor 435 receives a request to back up the data 450 included in the source database 410 (block 505). In some embodiments, the request is sent by the fourth electronic computing device 405 when the fourth electronic processor 425 executes the backup service 430. In response to receiving the request to back up the data 450 included in the source database 410, the first electronic processor 435 writes or sends a backup of the data 450 included in the first memory 440 of the source database 410 to the cloud storage system 205 (block 510). The first electronic processor 435 writes or sends metadata associated with the backup of the data 450 to a table 455 included in the first memory 440 of the source database 410 (block 515). At a future time, the backup metadata included in the table 455 is used to retrieve the data 450 and restore a target database to a previous state of the source database 410. In some embodiments, the table 455 is an internal table which is not accessible to the user. In some embodiments, a user is able to view the backup metadata included in the table 455 but is unable to edit the table 455. When the backup is complete, the first electronic processor 435 generates a notification of completion of the backup of the source database 410 (block 520). In other embodiments, the first electronic processor 435 does not receive a request to backup the source database 410. Instead, the first electronic processor 435 periodically backs up the data 450 included in the source database 410 by performing blocks 510 and 515. For example, the first electronic processor 435 may perform blocks 510 and 515 every twenty-four hours.

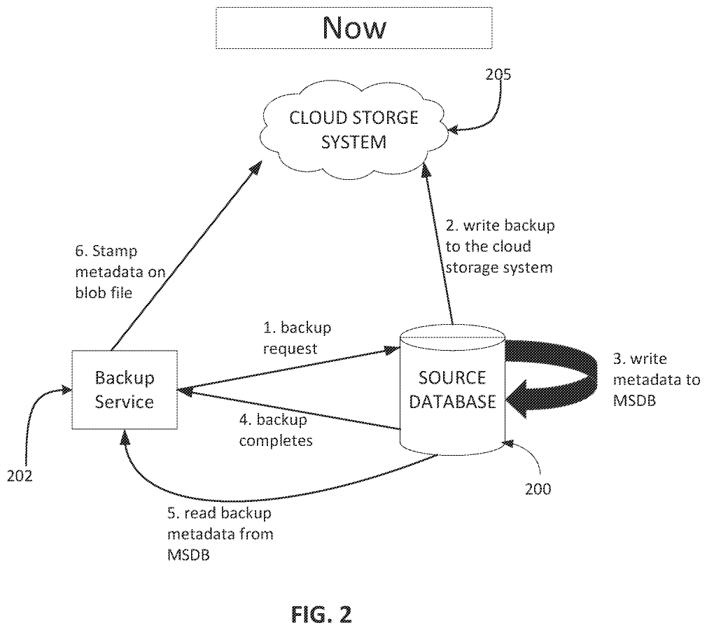

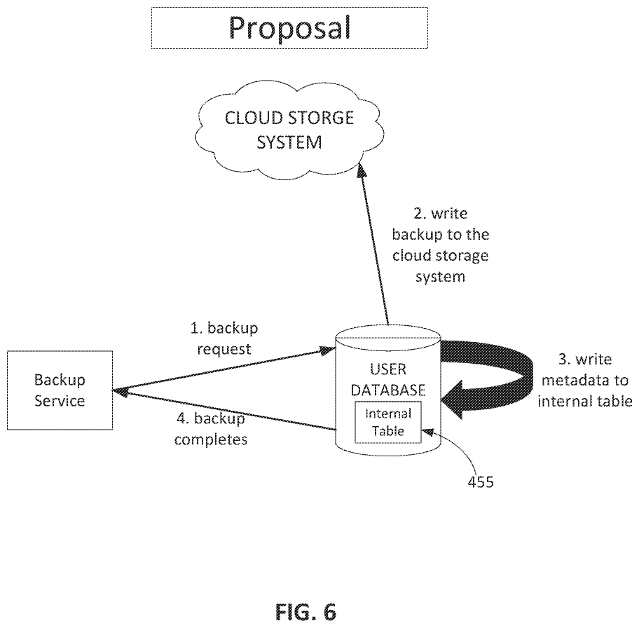

FIG. 6 is a graphical illustration of the method 500 that visually illustrates differences between existing systems and methods for performing database backups and the solution described herein. Unlike traditional systems and methods, in the system and method illustrated in FIG. 5 and FIG. 6, backup metadata is written to the table 455 rather than to a system database (for example, MSDB). Because the backup metadata is written to the table 455, FIG. 5 and FIG. 6 do not include the steps of reading the backup metadata from the MSDB and writing the metadata to the cloud storage system 205 (steps “5. read backup metadata from the MSDB” and “6. Stamp metadata on blob file” in FIG. 2).

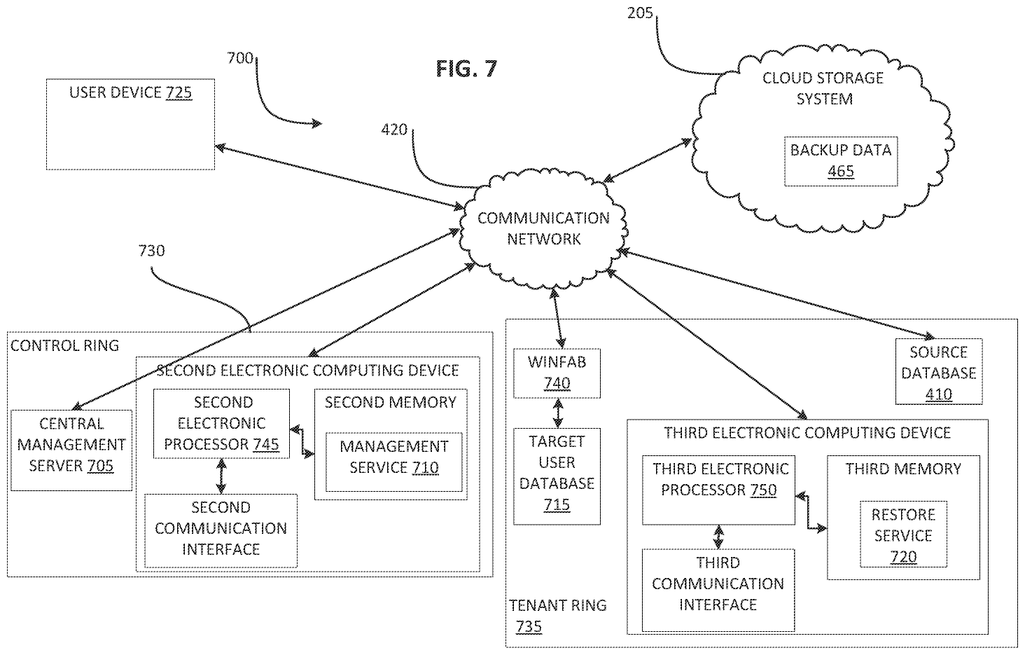

FIG. 7 provides an example illustration of a system 700 for database restoration with a reduced number of reads and writes to and from a cloud storage system. Similar to the system 400, the system 700 includes the source database 410 and cloud storage system 205. The system 700 also includes a central management server 705, a management service 710, a target database 715, a restore service 720, and a user device 725. The central management server 705, management service 710, target database 715, restore service 720, user device 725, source database 410, and cloud storage system 205 are communicatively coupled via a communication network 420. The central management server 705 and the management service 710 are illustrated in FIG. 7 as being included in a control ring 730. In some embodiments, the control ring 730 includes devices which may communicate with the electronic devices of multiple tenants or multiple tenant rings (for example the tenant ring 735). In some embodiments, the tenant ring 735 includes electronic computing devices associated with a single tenant. In some embodiments, the control ring 730 may communicate with the target database 715 through the use of one or more APIs (for example, a WinFab 740 service fabric). In some embodiments, the target database 715 is created or allocated as a result of a restore request and is populated with backup data that the cloud storage system 205 received from the source database 410. In some embodiments, when the target database 715 is created, the restore service 720 is activated. In some embodiments, other services are also activated when the target database 715 is created. The single tenant ring 735 shown in FIG. 7 is merely illustrative and the system 700 may include multiple tenant rings associated with a variety of tenants. It should be understood that the tenant ring 735, control ring 730, or both may include different components than those illustrated in FIG. 7. In some embodiments, the restore service 720 and management service 710 may be stored and executed on electronic computing devices similar to the fourth electronic computing device 405 that executes the backup service 430.

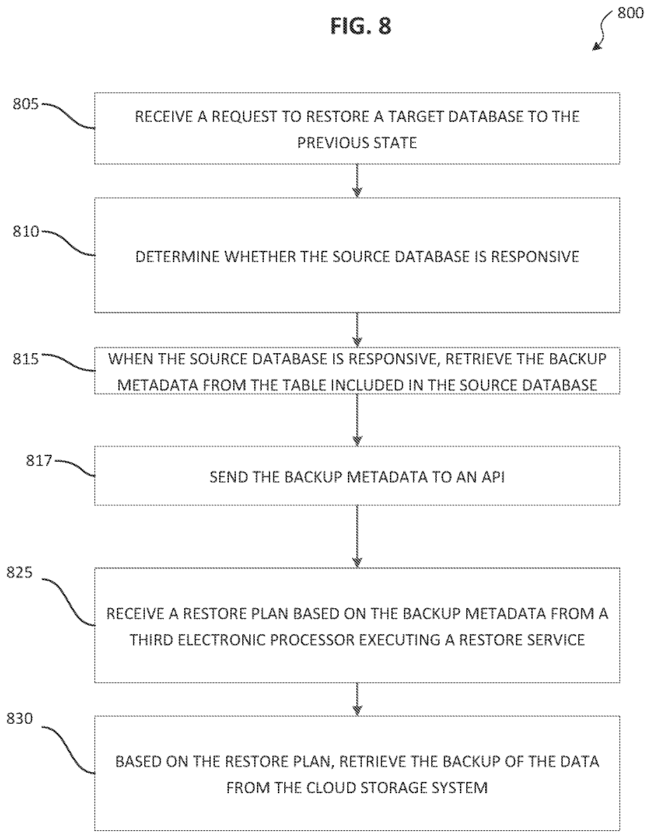

FIG. 8 illustrates an example method 800 for restoring a target database (for example, the target database 715) to a previous state of the source database 410. The method 800 begins when a second electronic processor 745 executing the management service 710 receives a request to restore the target database 715 to the previous state from a user device (for example, the user device 725) (block 805). The request may include a selected time or date (for example, 3 days ago or Mar. 2, 2021) and the previous state of the source database 410 may be the data that source database 410 included at the selected time. The second electronic processor 745 determines whether the source database 410 is responsive (block 810). For example, in some embodiments, the second electronic processor 745, when executing the management service 710, may query the central management server 705 to determine or check whether the source database 410 is in an unresponsive state (for example, the source database 410 is in an unresponsive state if the source database 410 has been deleted). In other embodiments, the second electronic processor 745, when executing the management service 710, may query the source database 410 to determine or check whether the source database 410 is in an unresponsive state (for example, the source database 410 is in an unresponsive state if the source database 410 is in a process hung state). The source database 410 is responsive when the source database 410 responds to communications sent via the communications network 420. When the source database 410 is responsive, the second electronic processor 745 retrieves the backup metadata from the table 455 included in the source database 410 (block 815). The second electronic processor 745 sends the backup metadata, a restore flag, or both to an API or a communication layer between the control ring 730 and the tenant ring 735 (for example, a WinFab 740 service fabric) (block 817). When a third electronic processor (for example, the third electronic processor 750) executing a restore service 720 detects the presence of the backup metadata, a restore flag, or both in the WinFab 740 service fabric, the third electronic processor 750 executing the restore service 720 reads the backup metadata from the WinFab 740 service fabric and generates a restore plan based on the backup metadata. The target database 715 receives the restore plan based on the backup metadata from the third electronic processor 750 executing a restore service 720 (block 825). The restore plan may include which backups need to be retrieved from the cloud storage system 205 in order to restore the target database 715 to the previous state of the source database 410. In some embodiments, each backup taken of the source database 410 may not include all of the data 450 included in the source database 410. For example, a backup may only preserve the portions of the data 450 included in the source database 410 that have been changed since the most recent backup. Therefore, data preserved during multiple backups may need to be retrieved in order to restore the target database 715 to its previous state. Based on the restore plan, the target database 715 retrieves the backup of the data (the backup data 465) from the cloud storage system 205 (block 830).

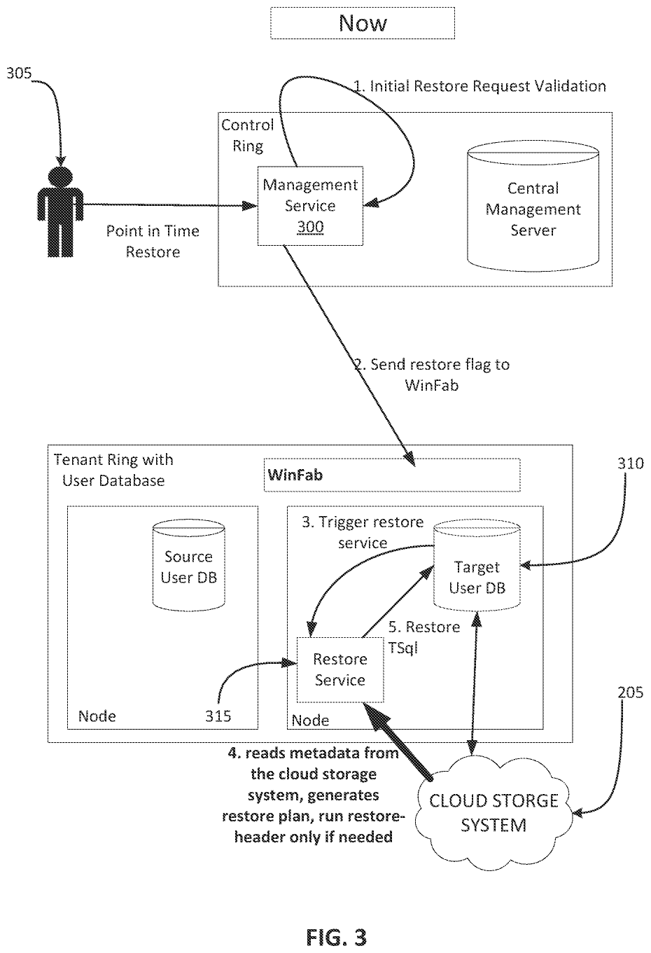

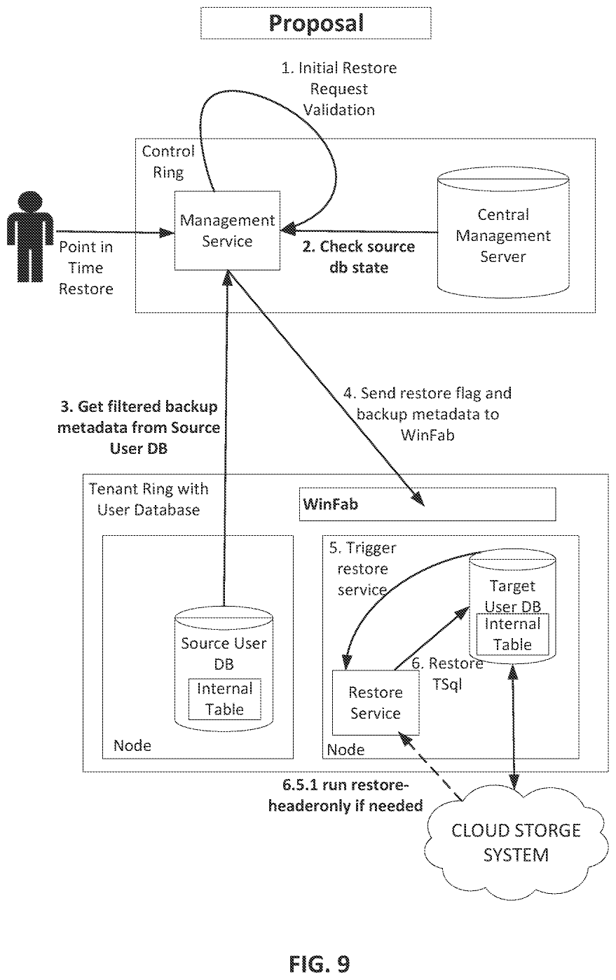

FIG. 9 is a graphical illustration of the method 800 that visually illustrates the differences between existing systems and methods for performing database restores and the solution described herein. Unlike existing systems and methods, the system and method illustrated in FIG. 8 and FIG. 9 include the steps of checking to see whether the source database 410 is responsive and, when the source database 410 is responsive, retrieving the backup data from the table 455 included in the source database 410 (steps “2. Check source db state” and “3. Get filtered backup metadata from the Source User DB” in FIG. 9). However, unlike the systems and methods illustrated in FIG. 8 and FIG. 9, existing systems and methods include the step of reading backup metadata from the cloud storage system 205 (for example, step “4. reads metadata from cloud storage system, generates plan, run restore-headeronly if needed” in FIG. 3).

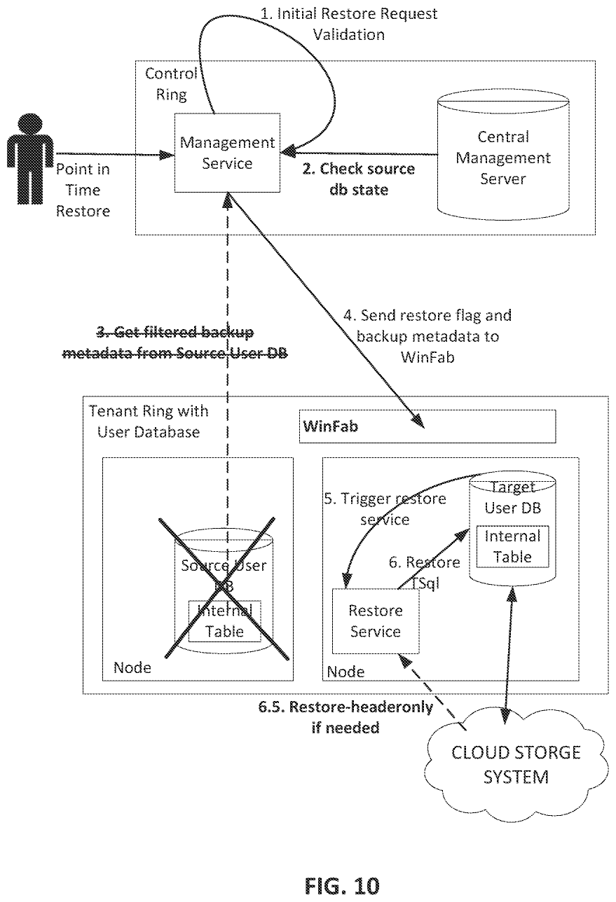

FIG. 10 illustrates an example system and method for restoring a target database to a previous state when the source database 410 is unresponsive. In this case, when the second electronic processor 745 determines whether the source database 410 is responsive at block 810, the second electronic processor 745 receives an indication that the source database 410 is not responsive. When the second electronic processor 745 determines that the source database 410 is unresponsive, the second electronic processor 745 does not query the source database 410 for metadata. Instead, a third electronic processor 750, executing the restore service 720, triggers a restore program (for example, “restore-headeronly”) included in the cloud storage system 205. The restore program has the capability to restore unavailable or lost metadata.

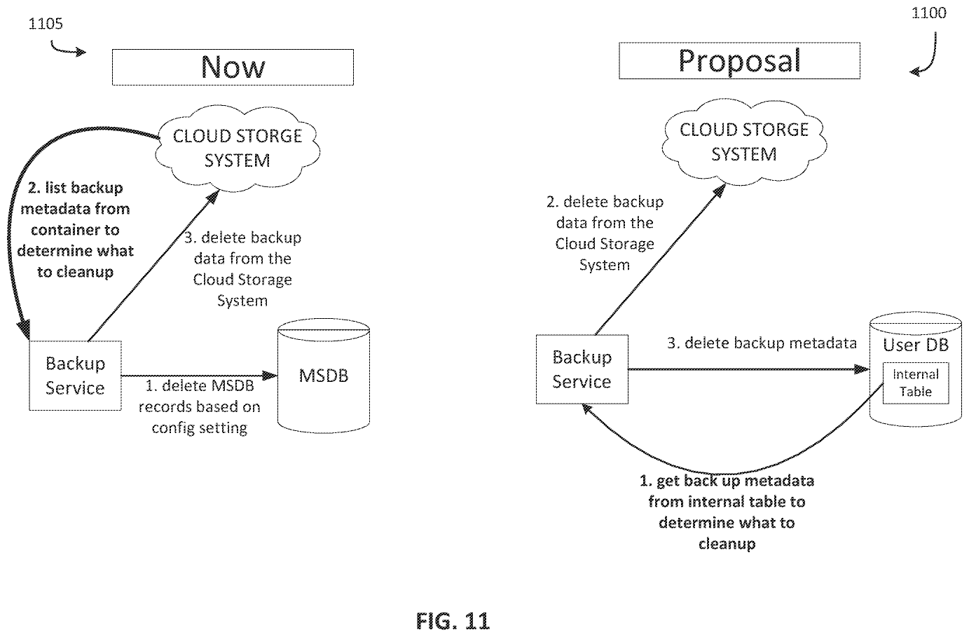

When executing the backup service 430 the fourth electronic processor 425 is configured to periodically delete backup data and backup metadata. For example, the fourth electronic processor 425 may be configured to delete backup data and backup metadata once every twenty-four hours. The fourth electronic processor 425 begins deleting backup data and backup metadata by retrieving backup metadata from the source database 410. Based on the backup metadata, the fourth electronic processor 425 determines a subset of backup metadata to delete from the table 455 and a subset of the backup data 465 to delete from the cloud storage system 205. For example, the fourth electronic processor 425 may be configured to delete backup data and backup metadata saved or written over a month ago and may use the backup metadata to determine backup data and backup metadata that was stored over a month ago. The fourth electronic processor 425 deletes the subset of backup data from the cloud storage system 205 and deletes the subset of backup metadata from the table 455 in the source database 410. FIG. 11 illustrates the above described method as system and method 1100 and the traditional data backup and backup metadata deletion method as system and method 1105. As can be seen, by comparing the system and method 1100 to the system and method 1105 the system and method 1100 does not require reading backup metadata from the cloud storage system 205 while the traditional system and method 1105 does.

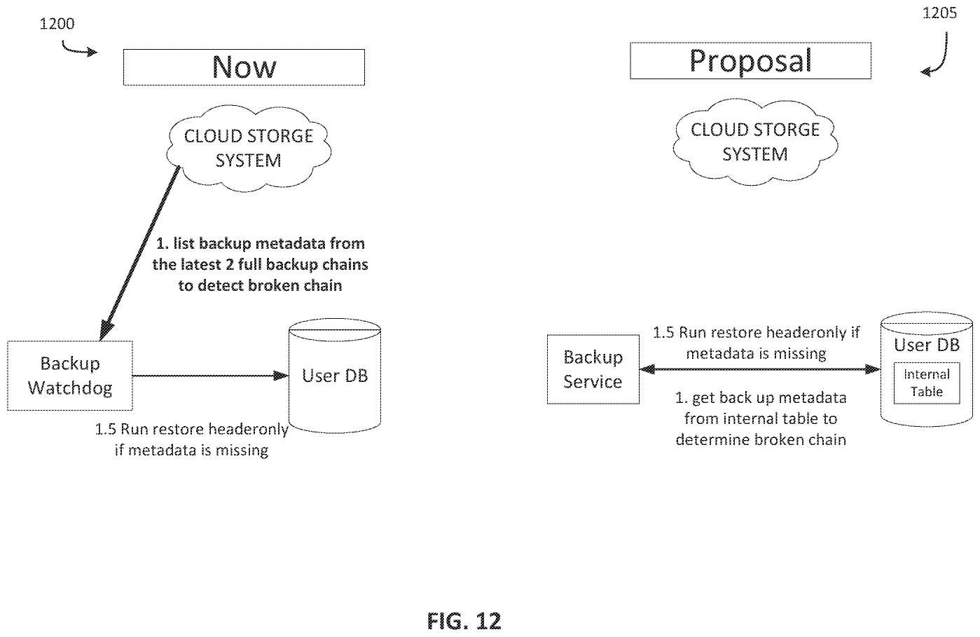

FIG. 12 illustrates systems and methods for detecting and restoring missing backup metadata. System and method 1200 follow the traditional method of detecting and restoring missing backup metadata. In the traditional method, the fourth electronic processor 425 retrieves backup metadata associated with the two most recent backup chains. A backup chain is a sequence in which back up data is backed up from the source database 410. The fourth electronic processor 425 determines whether any metadata is missing from the retrieved backup metadata. If metadata is missing from the metadata chains the fourth electronic processor 425 executes a restore program to restore the metadata. The system and method 1205 illustrate detecting and restoring missing backup metadata using table 455 described herein. Unlike in the traditional method, when system and method 1205 is employed backup metadata does not need to be retrieved from the cloud storage system 205. Instead backup metadata can be retrieved from the table 455 in the source database 410.

In some embodiments, to ensure that there is enough space in the first memory 440 of the source database 410 for the backup metadata, a predetermined amount of the first memory 440 (for example, one gigabyte) is initially filled with dummy data. When backup metadata needs to be written to the first memory 440, the at least a portion of the dummy data is deleted and replaced with backup metadata.

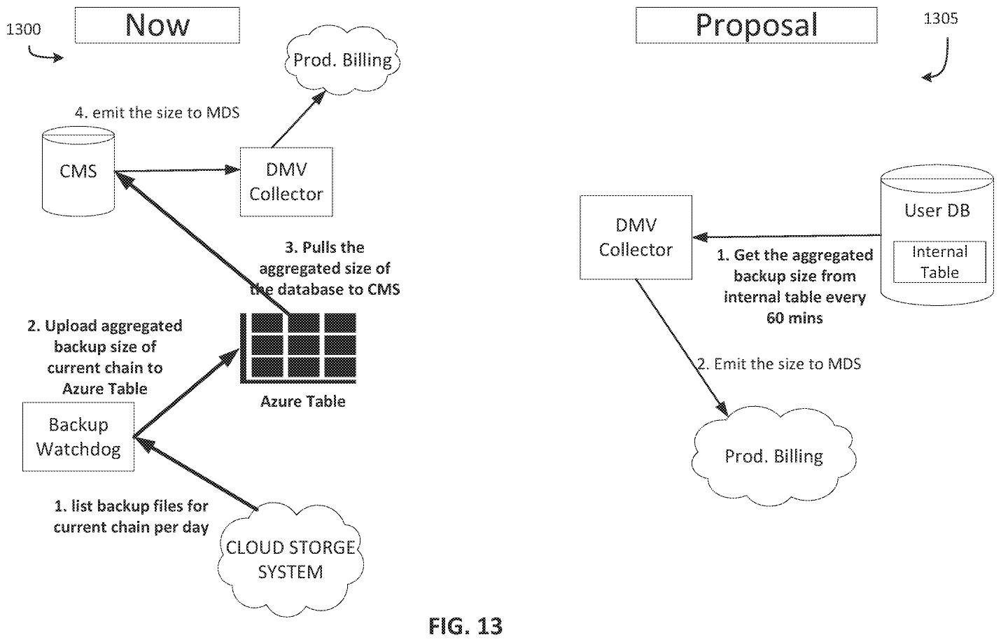

The systems and methods described herein also allow for easier billing of customers or users. Users are billed based on the amount of cloud storage space their backup data occupies in the cloud storage system 205. FIG. 13 illustrates the differences between billing users in a traditional system and billing users using the system 400 described herein. Diagram 1300 illustrates a method for billing users in a traditional database system. To determine the amount of cloud storage space that a user's backup data is occupying, the traditional system requires backup data to be read from a cloud storage system 205 and a write to a table (for example, an Azure® table). These operations are expensive. In contrast, diagram 1305 illustrates a method for billing users using the systems and methods described herein. Billing using the table 455 included in the source database 410 does not require these expensive operations to be performed because the amount of cloud storage space the backup data is occupying in the cloud storage system 205 can be retrieved directly from the table 455.

Thus, embodiments described herein provide, among other things, methods and systems for a system and method for limiting the number of reads and writes required to be made to a cloud storage system during database back up and restoration by persistently storing metadata associated with a backup of data in a source database.

Various features and advantages of some embodiments are set forth in the following claims.

What is claimed is:

1. A system for persistently storing metadata associated with a backup of data in a source database, the system comprising:
a cloud storage system; and
a source database comprising
a memory including data; and
a first electronic processor configured to
write a backup of the data included in the memory of the source database to the cloud storage system; and
write metadata associated with the backup of the data (“backup metadata”) to a table included in the memory of the source database, wherein the backup metadata is used to retrieve the data when a target database is restored to a previous state of the source database.

2. The system according to claim 1, wherein the first electronic processor is configured to
receive a request to backup the data included in the source database;
in response to receiving the request to backup the data included in the source database,
write the backup of the data included in the memory of the source database to the cloud storage system; and
write the backup metadata to the table included in the memory of the source database; and
when the backup is complete, generate a notification of completion of the backup of the source database.

3. The system according to claim 1, the system comprising
the target database; and
a second electronic processor configured to
receive a request to restore the target database to the previous state;
determine whether the source database is responsive;
when the source database is responsive, retrieve the backup metadata from the table included in the source database; and
send the backup metadata to an API; and
wherein the target database is configured to
receive a restore plan based on the backup metadata from a third electronic processor executing a restore service; and
based on the restore plan, retrieve the backup of the data from the cloud storage system.

4. The system according to claim 1, wherein the system includes a third electronic processor and the third electronic processor is configured to, when the source database is unresponsive, retrieve and execute a restore program from the cloud storage system.

5. The system according to claim 1, wherein the table is an internal table that is not accessible by a user.

6. The system according to claim 1, wherein the first electronic processor is configured to
fill a predetermined amount of the memory of the source database with dummy data; and
when the backup metadata is written to the memory of the source database, replace at least a portion of the dummy data with the backup metadata.

7. The system according to claim 1, wherein the system includes a fourth electronic processor configured to periodically delete a subset of backup data and a subset of backup metadata by
retrieving backup metadata from the source database;
based on the retrieved backup metadata, determining the subset of backup metadata to delete from the table and the subset of backup data to delete from the cloud storage system; and
deleting the subset of backup data from the cloud storage system and the subset of backup metadata from the table in the source database.

8. The system according to claim 7, wherein the fourth electronic processor is configured to detect and restore missing backup metadata by
retrieving backup metadata associated with a most recent backup chain from the table in the source database;
determining whether backup metadata is missing from the retrieved backup metadata; and
when backup metadata is missing from the retrieved backup metadata, executing a restore program to restore the missing backup metadata.

9. A method of persistently storing metadata associated with a backup of data in a source database, the method comprising:
sending, with a first electronic processor, a backup of data included in memory of a source database to a cloud storage system; and
sending, with the first electronic processor, metadata associated with the backup of the data (“backup metadata”) to a table included in the memory of the source database, wherein the backup metadata is used to retrieve the data when a target database is restored to a previous state of the source database.

10. The method according to claim 9, the method further comprising
receiving, with the first electronic processor, a request to backup the data included in the source database;
in response to receiving the request to backup the data included in the source database,
sending the backup of the data included in the memory of the source database to the cloud storage system; and
sending the backup metadata to the table included in the memory of the source database; and
when the backup is complete, generating a notification of completion of the backup of the source database.

11. The method according to claim 9, the method comprising
receiving, with a second electronic processor, a request to restore the target database to the previous state;
determining whether the source database is responsive;
when the source database is responsive, retrieving the backup metadata from the table included in the source database;
sending, with the second electronic processor, the backup metadata to an API;
receiving, with the target database a restore plan based on the backup metadata from a third electronic processor executing a restore service; and
based on the restore plan, retrieving, with the target database, the backup of the data from the cloud storage system.

12. The method according to claim 9, the method further comprising
when the source database is unresponsive, retrieving and executing, with a third electronic processor, a restore program from the cloud storage system.

13. The method according to claim 9, wherein the table is an internal table that is not accessible by a user.

14. The method according to claim 9, the method further comprising
filling a predetermined amount of the memory of the source database with dummy data; and
when the backup metadata is sent to the memory of the source database, replacing at least a portion of the dummy data with the backup metadata.

15. The method according to claim 9, wherein the method further comprising
periodically deleting, with a fourth electronic processor, a subset of backup data and a subset of backup metadata by
retrieving backup metadata from the source database;
based on the retrieved backup metadata, determining the subset of backup metadata to delete from the table and the subset of backup data to delete from the cloud storage system; and
deleting the subset of backup data from the cloud storage system and the subset of backup metadata from the table in the source database.

16. The method according to claim 9, the method further comprising
retrieving backup metadata associated with a most recent backup chain from the table in the source database;
determining whether backup metadata is missing from the retrieved backup metadata; and
when backup metadata is missing from the retrieved backup metadata, executing a restore program to restore the missing backup metadata.

17. A non-transitory, computer-readable medium storing instructions that, when executed by an electronic processor, perform a set of functions, the set of functions comprising:
writing, with a first electronic processor, a backup of data included in memory of a source database to a cloud storage system; and
writing, with the first electronic processor, metadata associated with the backup of the data to a table included in the memory of the source database, wherein the backup metadata is used to retrieve the data when a target database is restored to a previous state of the source database.

18. The non-transitory, computer-readable medium according to claim 17, the set of functions further comprising
receiving, with the first electronic processor, a request to backup the data included in the source database;
in response to receiving the request to backup the data included in the source database,
writing the backup of the data included in the memory of the source database to the cloud storage system; and
writing the backup metadata to the table included in the memory of the source database; and
when the backup is complete, generating a notification of completion of the backup of the source database.

19. The non-transitory, computer-readable medium according to claim 17, wherein the table is an internal table that is not accessible by a user.

20. The non-transitory, computer-readable medium according to claim 17, the set of functions further comprising
fill a predetermined amount of the memory of the source database with dummy data; and
when the backup metadata is written to the memory of the source database, replacing at least a portion of the dummy data with the backup metadata.
